(19) United States
(12) Patent Application Publication
(10) Pub. No.: US 2014/0149570 A1
(43) Pub. Date: May 29, 2014

(54) PROVISIONING IP TERMINALS

(71) Applicant: VIDEXIO AS, Lysaker (NO)

(72) Inventors: Thomas Midtskogen BERGER, Oslo (NO); Tom-Erik LIA, Askim (NO); Michel Asbjorn SAGEN, Hosle (NO)

(73) Assignee: Videxio AS, Lysaker (NO)

(21) Appl. No.: 13/686,068

(22) Filed: Nov. 27, 2012

(51) Int. Cl. H04L 29/12

(52) U.S. Cl. CPC H04L 29/12216
USPC 709/224

(57) ABSTRACT

A method for identifying and remotely provisioning IP terminals like video conference endpoints connected to a common LAN. A provisioning server sends email with a provisioning URL to user being asked to activate the URL; the computer receiving the email is connected to the LAN. Activation establishes an http session between the computer and a provisioning server, the server delivering a Java applet to the computer. When the Java applet is executed, it extracts the IP address of the computer. The Java applet then scans the LAN for video communication endpoints by sending out signaling protocol request like SIP or H.323 requests addressed with IP addresses belonging to the same IP address segment as the computer's IP address. The computer then provision the IP units responding to the signaling protocol requests by inserting XML files into the endpoints adjusted to the certain systems units identified via the endpoints' API.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention relates to provisioning of IP communication terminals.

### BACKGROUND OF THE INVENTION

The IP (Internet Protocol) data network has created a number of opportunities and challenges for multimedia and voice Communications Service Providers. Unprecedented levels of investment are being made in the data network backbone by incumbent telecommunication operators and next generation carriers and service providers. At the same time, broadband access technologies are bringing high speed Internet access to a wide community of users. Service providers would like to make use of the IP data network to deliver voice, video and data services right to the desktop, the office and the home alongside high speed Internet access.

The H.323 standard applies to multimedia communications over Packet Based Networks that have no guaranteed quality of service. It has been designed to be independent of the underlying transport network and protocols. Today the IP data network is the default and ubiquitous packet network and the majority of implementations of H.323 are over an IP data network. Other protocols for real-time (voice and video) communications, for example, SIP (Session Initiated Protocol) also use the IP data network for the transport of call signaling and media. New protocols for new applications associated with the transport of real-time voice and video over IP data networks are also expected to be developed.

Hitherto, there have been a number of barriers to the mass uptake of multimedia (particularly video) communications. Ease of use, quality, cost and communications bandwidth have all hampered growth in the market. Technological advances in video encoding, the ubiquity of cheap IP access and the current investment in the data network now alleviates most of these issues making multimedia communications readily available.

Service provider networks typically utilize packet-switched IP networks through which multiple enterprise subscriber networks may access a global IP network, such as the Internet. Typically, the service provider network includes an access point, such as a POP. The POP has a unique IP address that a device on the enterprise subscriber network may contact to access network.

Traffic coming into the POP can be classified into videoconferencing data and non-videoconferencing data. Videoconferencing data typically includes control data and streaming voice and audio data according to the H.323 or SIP standards. H.323 refers to International Telecommunications Union, Telecommunications Sector, Recommendation H.323 (version 1, published November 1996; version 2, published 1998, entitled, “Visual Telephone Systems and Equipment for Local Area Networks Which Provide a Non-guaranteed Quality of Service,”. SIP refers to Session Initiation Protocol Proposed Standard (RFC 2543), Internet Engineering Task Force (IETF) (published March 1999).

Each of the enterprise subscriber networks typically includes a plurality of terminals. Terminals, along with video conferencing service switches and the various other components of system, are typically H.323 or SIP compliant. The terminals are typically videoconferencing devices configured to display and record both video and audio. The terminals may be desktop computers, laptop computers, mainframes and/or workstation computers, or other videoconferencing devices

In video conferencing, provisioning means inserting required system data in the endpoint such as access information to the VSP (Video conference Service Provider), user credentials, identification of the subscriber in the VSP architecture which typically could be an URI, etc. Provisioning is traditionally done either manually by typing the required data in a User Interface on each endpoint, or remotely from a Video conferencing Management Suit where the endpoints are already registered. The provisioning process is one of many technical thresholds for the use of video conference equipment. A user is rarely trained in inserting advanced settings in an endpoint. When batches of endpoints are to be provisioned, manual provisioning will be too time consuming, and the risk of an erroneous insertion of data is high. There is a need for a process for identifying endpoints connected to a network and for automatically provisioning the identified endpoints with the correct provisioning data e.g. when a new subscriber at a VSP is to initiate the subscription and connect its endpoint to the VSP's network.

### SUMMARY OF THE INVENTION

The subject matter of the present invention is a method for provisioning one or more IP terminals connected to a IP network, by running a computer executable code on the computer which includes the steps of extracting the IP address of the computer, respectively addressing one or more media communication protocol requests for all IP addresses in the range or segment in which the IP address of the computer belongs, and unicasting them in the first IP network from the computer, identifying the one or more IP terminals and corresponding media communication protocol from media communication protocol responses received by the computer and remotely provisioning the one or more IP terminals from the computer and/or the provisioning server. The subject matter of the invention also includes a corresponding computer program and a provisioning system.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIGS. 1A and 1B show examples of components that may be hosted by a VSP;

FIG. 2 shows the components of FIG. 1 in a global architecture of a VSP network;

FIG. 3 illustrates a computer and video endpoints in a LAN;

FIG. 4 is an example of the content of an activation email from a VSP;

FIGS. 5A and 5B illustrate the data flow between the provisioning server, the LAN and internally in the LAN according to one embodiment of the present invention; and

FIG. 6 shows an example of the content of an XML file used to provision video endpoints.

### DETAILED DESCRIPTION OF THE INVENTION

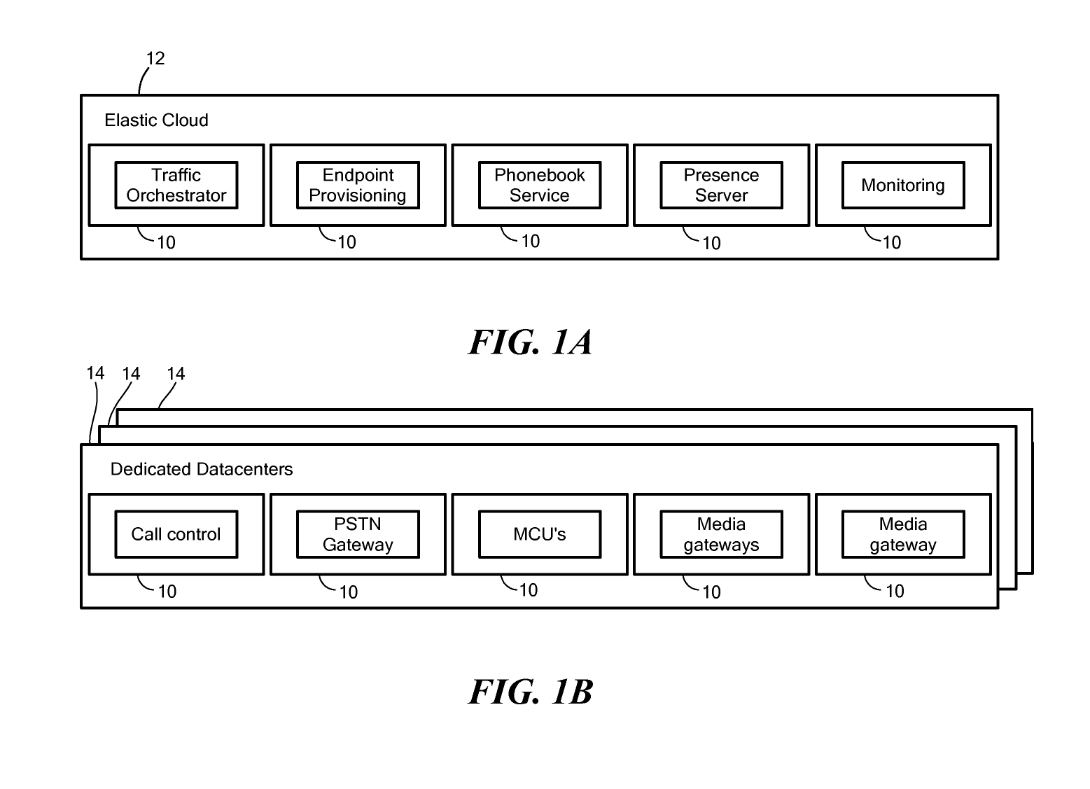

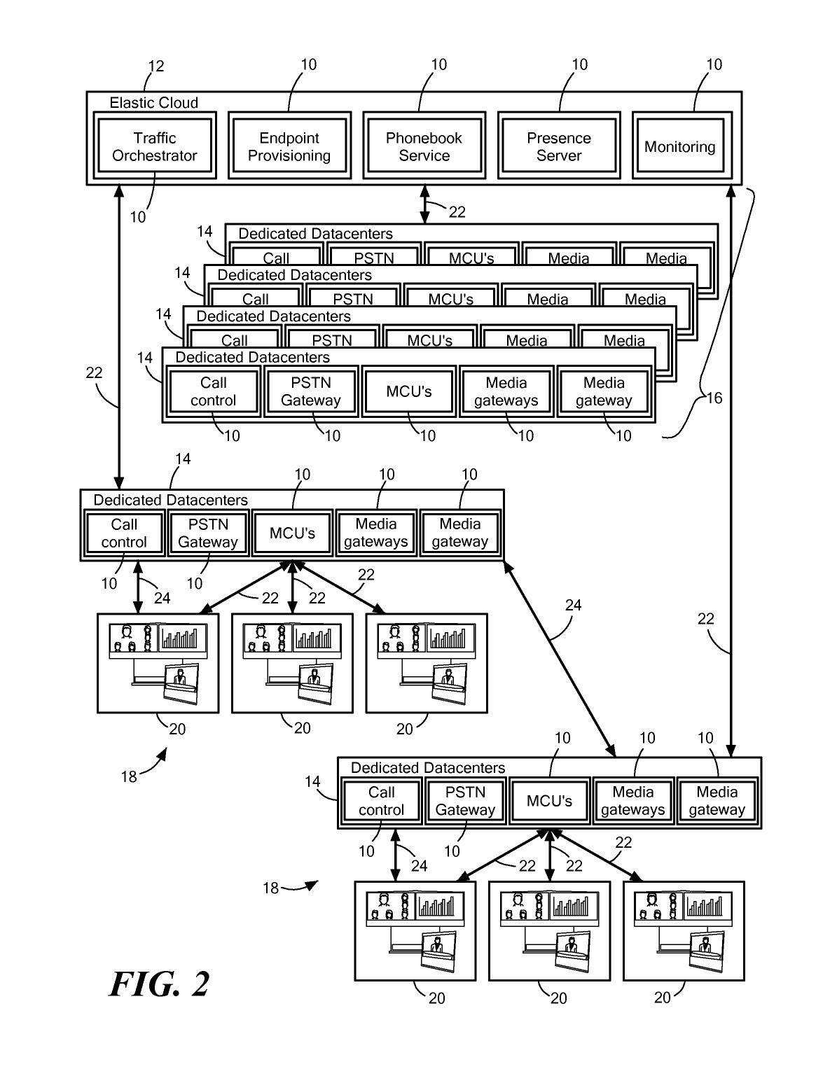

FIGS. 1A and 1B show examples of the components 10 that may be hosted by a VSP providing video conference and related services to subscribers of the service through a public IP network. The components 10 are divided in two groups—elastic cloud 12 (as shown in FIG. 1A) and dedicated datacenters 14 (as shown in FIG. 1B). The elastic cloud 12 includes components 10 related to administration, monitoring and add-on services, while the dedicated data centers 14 include components 10 related to handling media like gateways for converting video data between different formats and standards, Multipoint Control Unit (MCU) for bridging and mixing video conferencing connections providing the capability for 3 or more terminals and gateways to participate in a multipoint conference and call control e.g. providing firewall traversal and NAT conversion of media data. FIG. 2 further illustrates the elastic cloud 12 and the dedicated data centers 14 in a global architecture of a VSP network. The dedicated datacenters 14 could either reside centrally in the cloud 16 or being distributed and dedicated to each LAN 18 to which the subscribers' video terminals 20 are connected. The elastic cloud 12 is located centrally through which only signaling 22 is routed, while the media flow 24 is routed directly between the dedicated data centers 14.

The present invention is related to one of the specific components in the elastic cloud, namely the endpoint provisioning component. As already mentioned provisioning in telecommunication is the process of preparing and equipping terminals to allow it to be provided with services to a service provider's subscribers. It is also equates to “initiation” and includes altering the state of an existing priority service or capability. In video conferencing, provisioning means inserting required system data in the endpoint such as access information to the VSP, user credentials, identification of the subscriber in the VSP architecture which typically could be an URI, etc. Provisioning is traditionally done either manually by typing the required data in a User Interface on each endpoint, or remotely from a Video conferencing Management Suit where the endpoints are already registered.

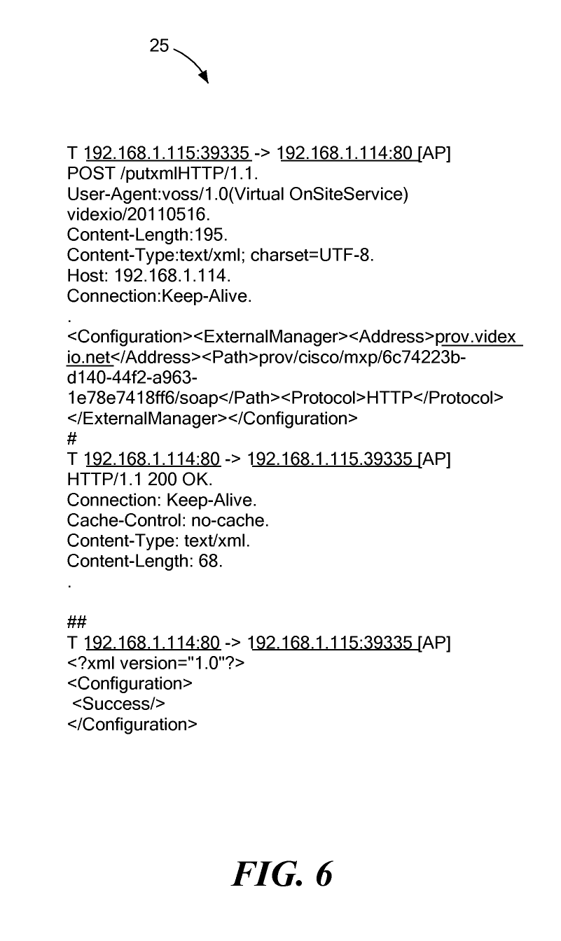

The present invention discloses a method, computer program and device for identifying and provisioning IP terminals like video conference endpoints connected to a common LAN. According to one embodiment of the invention, a provisioning server sends an email with a provisioning URL to a user which is being asked to activate the URL while the computer receiving the email is connected to the LAN. At activation, an http session is established between the computer and a provisioning server. The provisioning server then delivers configuration details for the subscription together with a Java applet which is executable on a Java virtual Machine on the computer. The Java applet starts by extracting the IP address of the computer. It then scans the LAN for video communication endpoints by sending out media protocol request like SIP or H.323 requests addressed with IP addresses belonging to the same IP address segment as the computer's IP address. The computer then provision the IP units responding to the media protocol requests by inserting required settings into the endpoints via XML files 25 (for example, as shown in FIG. 6) adjusted to the certain systems units identified.

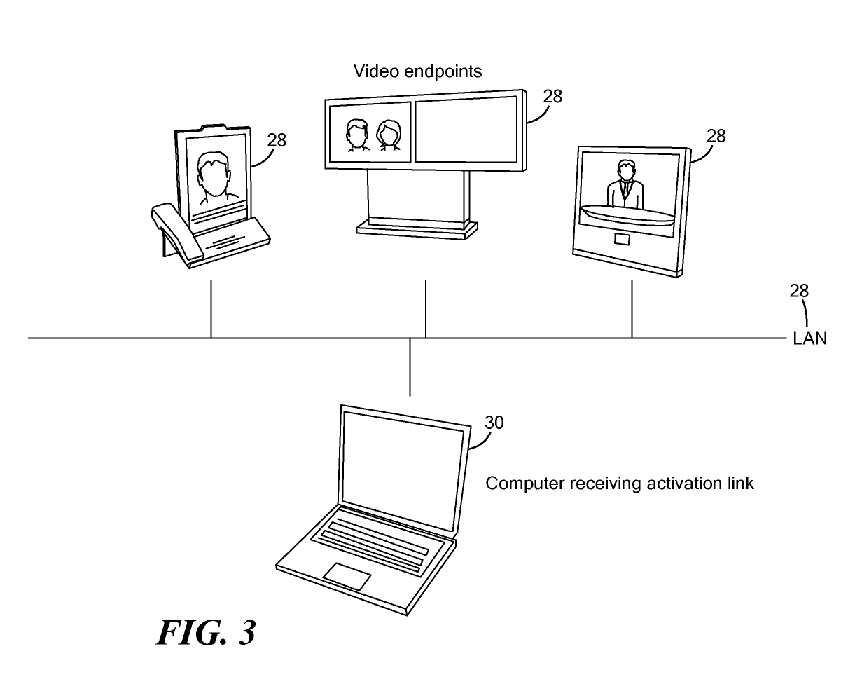

In the following, an example embodiment of the present invention will be further described. FIG. 3 illustrates a LAN 26 with a three video endpoints 28 and a computer 30 connected thereto. The LAN 28 could e.g. be a new VSP subscriber's LAN where the endpoints are still not provisioned to the VSP network.

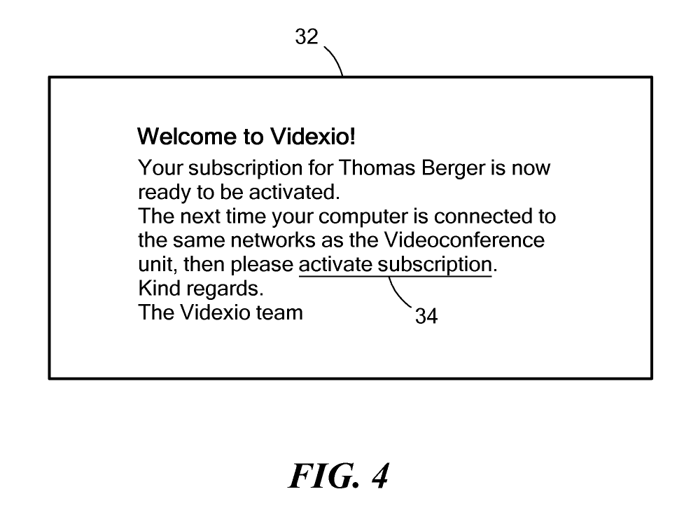

According to the example embodiment, the provisioning process is initiated when a provisioning email is being sent to an email address given by the new subscriber. A user at the new subscriber opens the email 32 that may appear as illustrated in FIG. 4. The email 32 includes a link 34 and an instruction to the user to click on the link when the computer (PC) is connected to the same network (LAN) as the endpoint to be provisioned.

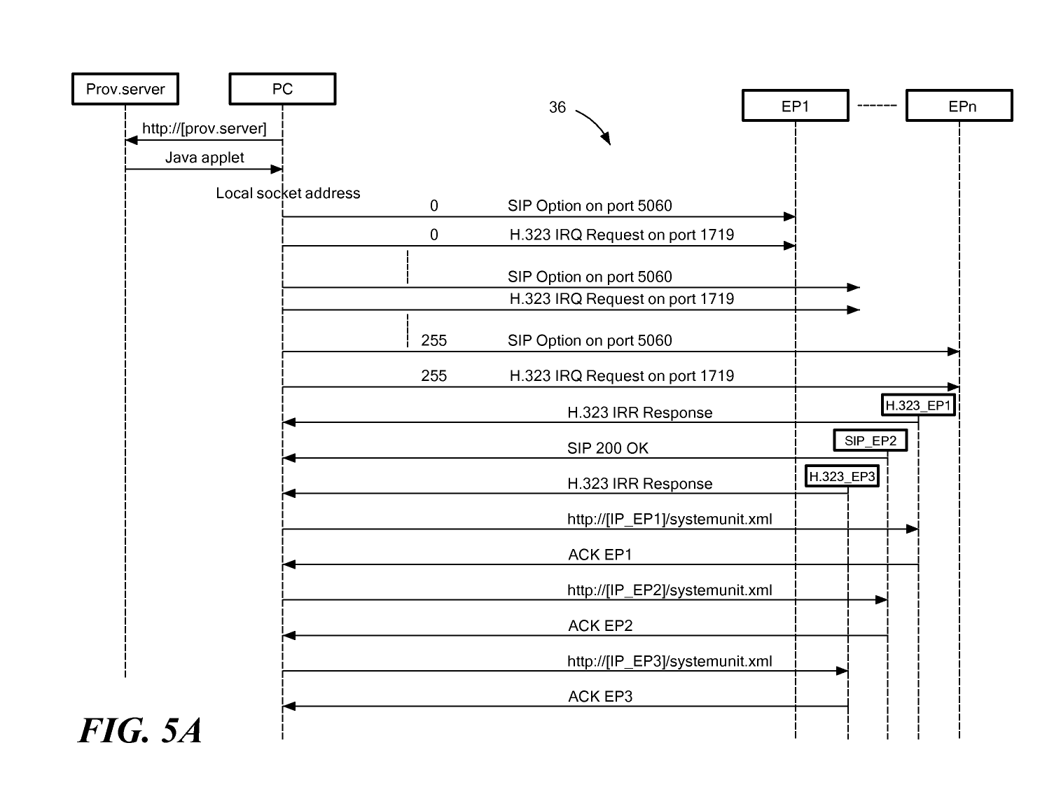

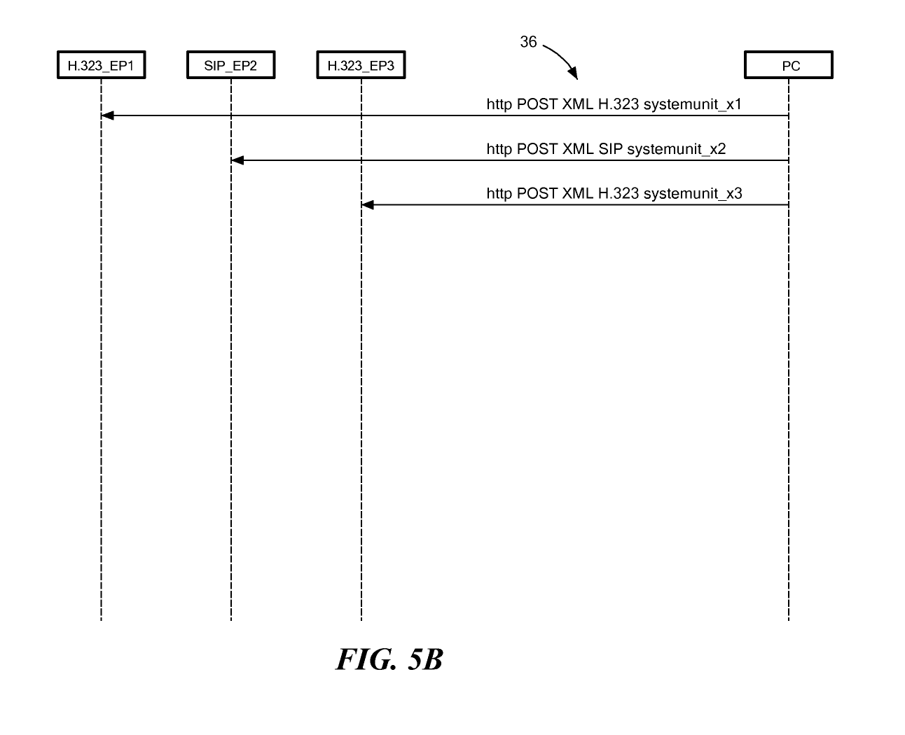

The provision process starts when the user clicks on the link 34. FIGS. 5A and 5B show the message flow 36 during the provisioning process on a high level including both IP, SIP and H.323 terminology. The terms are not necessarily precisely according to standards, but still sufficiently descriptive so that a person skilled in the art would be able to reconstruct the process.

The link 34 in the email 32 is addressed to the provisioning server at the VSP. Therefore, an http request is sent from the computer to the provisioning server. The provisioning server is adjusted to respond to the http request by delivering a Java applet (or any other code packages similar to Java applet). In an alternative embodiment of the invention, the Java applet (or similar) is provided to the computer 30 without the initial http connection with the provisioning server, but brought to the computer 30 in e.g. a memory stick or via a hand held device through wireless transfer.

The Java applet contains instructions to the computer 30 on how to proceed, and is executable on a Java Virtual Machine (JVM) preferably preinstalled on the computer 30. The applet starts by extracting the computer's IP address with an internal “Request local socket address”, the computer 30 responds with a “Local socket address” which includes the IP address of the computer 30.

The applet is now aware of one IP address of the local network to which the endpoints 28 are connected. The present invention utilizes the fact that the IP addresses assigned to IP units connected to the same LAN 26 defined as a subnet most often belongs to one IP address segment, which usually is of the size 256. When one IP address is known, the segment is therefore also known, and there will in most cases be 256 possible IP addresses assigned to the IP units in the LAN. The video conference units of today are adjusted to communicate either according to the SIP standard or the h.323 standard (or both). When sending a SIP request to units in an IP network, only SIP units will respond, and sending an h.323 request to units in an IP network, only h.323 units will respond. According to the present invention, one SIP request message and one h.323 request message are unicasted from the computer 30 to all possible IP addresses in the segment of the computer's LAN 26. As illustrated in FIG. 5A, a SIP Option message is sent out on port 5060 and an h.323 IRQ Request message is sent out on port 1719 on all 255 possible IP addresses that can be hosted on the LAN 26. The ports 5060 and 1719 are chosen because video conference endpoints always are “listening” to these ports. Port 1718 could also be used to facilitate a broadcast, but port 1719 is used as it will give more hits.

The result of sending out SIP and h.323 requests on the above-mentioned ports addressing them to all IP addresses in the segment to which the IP address of the computer 30 belongs, is that no one but all endpoints 28 connected to the same LAN 26 as the computer 30 will respond. What kind of responses will depend on whether the endpoints 28 are SIP or H.323 units. Most SIP units will respond with 2000K and h.323 units will respond with IRR Response. These responses include, inter alia, the IP addresses of the responders. In the example illustrated in FIG. 5B, three endpoints 28 are responding to the requests sent out from the provisioning server, one SIP unit (SIP_EP2) and two h.323 units (h.323_EP1 and h.323_EP3).

At this point, the computer 30 has identified the IP addresses of the endpoints 28 connected to the new subscriber's LAN 26 and to which standard they are configured. However, provisioning of video endpoints 28 vary from one unit to another. As an example, a Cisco EX90 unit has a different format of the provisioning file to be inserted via the codec API than a Polycom HDX 4500 (Video endpoints are always equipped with a codec for coding and decoding media data, and most often have Application Programming Interface (API) installed). Therefore, to complete the provisioning process, the computer 30 also needs to have system information of the identified video conferencing unit. System information can be accessed through various different URLs. Based on the response from the SIP or H.323 probes, you might try different URLs or other API requests to access the IP terminal. On a Cisco Telepresence unit the preferred URL would be http://IP/systemunit.xml, where IP is the unit's IP address. The system information of a Cisco EX60 unit with the IP address 192.168.1.114, can be accessed through the URL http://192.168.1.114/systemunit.xml. The PC creates an URL for all known system units including the respective IP addresses of the identified video conferencing units. Information gathered are presented to the user so he/she can visualize the IP terminals found and give the user a possibility to choose the correct IP terminal to provision. In the example illustrated in FIGS. 5A and 5B, only endpoints from one vendor are present, so that the same URL format can be used. When an URL complies with the system unit type of one of the endpoints, it will respond with an acknowledge message including identification of the responder and the system unit.

The PC 30 has in the example of FIG. 5A identified all information required to carry out a remote provisioning of the video conferencing units 28 connected to the LAN 26. Remote provisioning can be done by establishing a http connection to the video conference unit 28 (or other API used), and inserting an XML post into the unit through the API of the incorporated codec. FIG. 5B shows how the XML files 25 are inserted into the endpoints by POST commands including XML files 25 adjusted to the system unit types already identified for the respective endpoints. The XML file 25 may in turn include an URL to the provisioning server which is being activated by the endpoint, so that the settings are actually loaded from the provisioning server to the endpoint, which will complete the provisioning process.

When the process is completed an email can be sent to the subscriber with a list of endpoints that have been provisioned successfully. In the embodiments discussed above, only SIP and H.323 adjusted video endpoints are discussed. However, provisioning of IP terminals using other media communication protocols could be imaginable for a person skilled in the art, and would be included in the scope of the present invention. The scope is neither limited to video communication, but would be useful also for provisioning of Voice over IP (VoIP) terminals. Note that the provisioning method according to the present is applicable for both first time provisioning and re-provisioning in the case where the user changes VSP or wishes to swap subscriptions between endpoints.

The scope of the present application as defined in the independent claims also includes special case LANs like WLAN or WiFi, and the computer is not limited to a traditional PC or laptop, but could be any kinds of computer devices included smart phones and video conferencing endpoints. Also within the scope of the present application as defined in the independent claims, the computer executable code is not limited to Java Applets running on JVM, but could also be code downloaded to and executed on a smart phone or cell phone app.

1. A method for provisioning one or more IP terminals connected to a first IP network, comprising:
running a computer executable code on a computer on the first IP network which includes:
(1) extracting the IP address of the computer;
(2) respectively addressing one or more media communication protocol requests for all IP addresses in the range or segment in which the IP address of the computer belongs, and unicasting them in the first IP network from the computer; and
(3) identifying the one or more IP terminals and corresponding media communication protocol from media communication protocol responses received by the computer remotely provisioning the one or more IP terminals from at least one of the computer and a provisioning server.

2. A method according to claim 1, wherein the method includes the following steps prior to running a computer executable code on a computer on the first IP network:
A. establishing a first http connection from the computer connected to the first IP network to a server connected to a second IP network; and
B. transmitting a computer executable code from the server to the computer.

3. A method according to claim 2, wherein step A is initiated when a URL is activated on the computer provided by the server in an email sent to a user accessing the computer.

4. A method according to claim 1, wherein step (1) includes a “request local socket address request”, and that the computer responds to the “request local socket address request” with a “local socket address” response providing the IP address of the computer.

5. A method according to claim 1, wherein step (4) further includes:
creating one URL from each of the n IP addresses identifying the one or more IP terminals and each of m number of known system units in the format http://[IP_address]/[system unit] resulting in m×n URLs;
attempting to establish an http connection for each of the m×n URLs; and
for each acknowledged http connection, respectively provisioning the one or more IP terminals by posting an XML file into each IP terminal selected according to system unit associated with the respective URL being acknowledged.

6. A method according to claim 5, wherein the XML file includes required settings for providing a respective one of the one or more IP terminals access to a network service.

7. A method according to claim 1, wherein the media communication protocol is SIP and/or H.323.

8. A method according to claim 1, wherein the one or more IP terminals are at least one of video conferencing endpoints, telepresence systems, and VoIP terminals.

9. A method according to claim 1, wherein the first IP network is a Local Area Network (LAN).

10. A method according to claim 1, wherein the computer executable code is a Java applet.

11. A provisioning system adjusted to provision one or more IP terminals connected to a first IP network, comprising:
means for establishing a first http connection from a computer connected to the first IP network to a provisioning device connected to a second IP network;
means for extracting the computer's IP address from the computer;
means for respectively addressing one or more media communication protocol requests for all IP addresses in the range or segment in which the IP address of the computer belongs, and unicasting them in the first IP network;
means for identifying the one or more IP terminals and corresponding media communication protocol from media communication protocol responses received by the computer; and
means for provisioning the one or more IP terminals from at least one of the computer and a provisioning server.
